(19) United States
(12) Patent Application Publication
(10) Pub. No.: US 2016/0291652 A1
(43) Pub. Date: Oct. 6, 2016

(54) REFRIGERATED ELECTRONIC BOARD FOR SUPERCOMPUTERS AND PROCESS FOR PRODUCING THE SAME

(71) Applicant: EUROTECH S.P.A., Amaro (IT)

(72) Inventors: Mauro ROSSI, Gemona Del Friuli (UD) (IT); Paulus Petrus Bernardus ARTS, Gemona Del Friuli (UD) (IT); Giampietro TECCHIOLLI, Amaro (UD) (IT)

(21) Appl. No.: 15/037,037

(22) PCT Filed: Nov. 12, 2014
(86) PCT No.: PCT/IT2014/000300

§ 371 Date: May 16, 2016

(30) Foreign Application Priority Data
Nov. 14, 2013 (IT) VI2013A000273

(51) Int. Cl. G06F 1/20

(52) U.S. Cl. CPC G06F 1/20

(57) ABSTRACT

Cooled electronic board (10) for supercomputing comprising:
a printed electronic circuit (11) whereon at least a electronic component (12) is fixed;
a heat exchanger (13) of the roll bond type thermally connected with the electronic component (12) to absorb, in use, a thermal flow generated by the latter.

The present invention concerns a cooled electronic board for supercomputing and a method for its manufacture.

In particular, the present invention concerns a cooled electronic board which is dedicated to be used within supercomputers.

With supercomputer it is to be understood a type of processing system which is designed to obtain extremely high calculation power, and dedicated to effect high performance calculation.

A need which is deeply felt in the field of supercomputers is that of having higher and higher computing capability densities, i.e. limiting more and more the dimensions of the computers with equal computing capabilities.

According to this need, the striving to minimize the dimensions of the electronic boards composing such computers is therefore very strong.

In particular, it is to be considered that the electronic components distributed on such boards generate a high thermal flow that must be dissipated not to damage the computer.

A first solution for the thermal dissipation, which is known today, is that of using finned dissipators, possibly provided with phase change dissipation devices which are known as heat pipes, which are terminally connected to the components to be cooled down and encounter a forced airflow, which is moved by fans.

Such a solution implies high dimensions not compatible with the tendency to the above-mentioned miniaturization.

A second traditional solution is that of providing the electronic board with a liquid-cooled plate.

This plate has a portion provided with a channels network, the channels being made by drilling or milling or insertion of a tubular serpentine and, in use, run through by a refrigerant fluid.

For example one can see the international patent applications WO 2012/014058 and WO2013/050813 in the name of the same applicant.

Today such cooling plates are realized by forming the channels network by drilling a massive plate, transversely to the thickness of the same.

Within the holes, plugs are disposed, which are externally threaded, according to a predefined design, such to close selectively some segments of the holes and for the desired path for the refrigerant fluid.

An alternative traditional method to obtain a predefined path for the refrigerant fluid, consists in the creation by milling, on an aluminium plate, a trace defining the cooling serpentine.

Such trace is then tightly covered by a thin aluminium cover which is shaped correspondingly to the plate and fixed tightly to it.

A further today known solution presents a tube which is modeled in such a way to correspond to the plate and is tightly fixed to this.

A further today known solution presents a tube which is shaped in such a way to correspond to the trace and is housed in the latter.

Such Tube is thermally coupled with the plate and, in this case, the cover is not necessary, since the tube defines per se a closed hydraulic circuit.

A drawback of such refrigerating plates is that they came out to be highly bulky and present a poor possibility to differentiate the refrigerating effect in specific regions of the electronic board.

Generally this plate has a face provided with protrusions distributed and dimensioned in such a way to adapt themselves in a complementary way to the protrusions determined by the electronic components fixed on the printed electronic circuit of the electronic board, i.e. of the components necessitating to be cooled down during the functioning.

Such a traditional plate is locally provided with cavities, whenever the components to be cooled down protrude from the board supporting them in such a way to interfere mechanically with the lower surface of the same plate.

Cavities for avoiding the mechanical interference with the components can be provided, which do not necessitate refrigeration, but whose protrusion is such to interfere with the same plate.

The problem underlying the same invention is that to reduce the dimensions of the known electronic boards for supercomputing.

The main task of the present invention is to realize an electronic board for supercomputing which is refrigerated and solve such problem by solving the above-mentioned drawbacks of the above-mentioned cooled electronic boards for supercomputing.

In the framework of such a task, it is object of the present invention to provide a cooled electronic board for supercomputing that presents a refrigeration or cooling down at least as efficient as the traditional boards.

Another object of the present invention consists in the realization of a cooled electronic board for supercomputing which is structurally more simple than the traditional ones.

A further object of the present invention is to propose a cooled electronic board for supercomputing which has the capability of differentiated refrigeration along its own extension.

Another object of the present invention is to realize a cooled electronic board for supercomputing which has greater flexibility of distribution of the outflow channels for the refrigerant liquid with respect to the traditional devices.

Still another object of the present invention consists in providing a process for producing a cooled electronic board for supercomputing which is simpler and cheaper with respect to the traditional processes.

A further object of the present invention consists in providing an electronic board for supercomputing and a process to produce it which allows to reduce significantly the weight with respect to the above-mentioned traditional solutions.

This task, as well as these and other objects which will better appear in the following are achieved by a cooled electronic board for supercomputing and a process to produce it according to the enclosed independent claims which are here integrally referred to.

Detail features of the cooled electronic board for supercomputing and the process for producing it according to the invention are given in the independent claims, which are here integrally referred to.

Further features and advantages of the invention will be more apparent from the description of a preferred but not limitating embodiment of the cooled electronic board for supercomputing and the process for producing it according to the invention, described by way of illustration by not by way of limitation in the enclosed drawings, wherein:

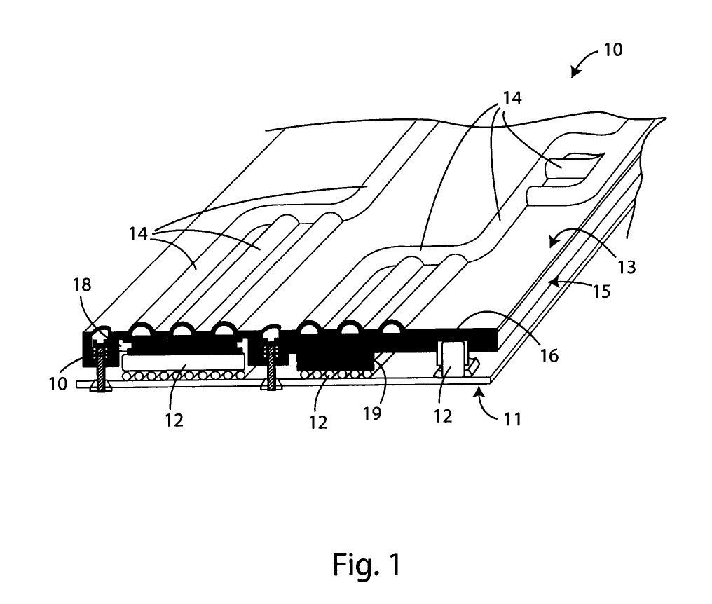

FIG. 1 illustrates a simplified diagram of a cooled electronic board for supercomputing according to the invention, in a perspective view, in partial section;

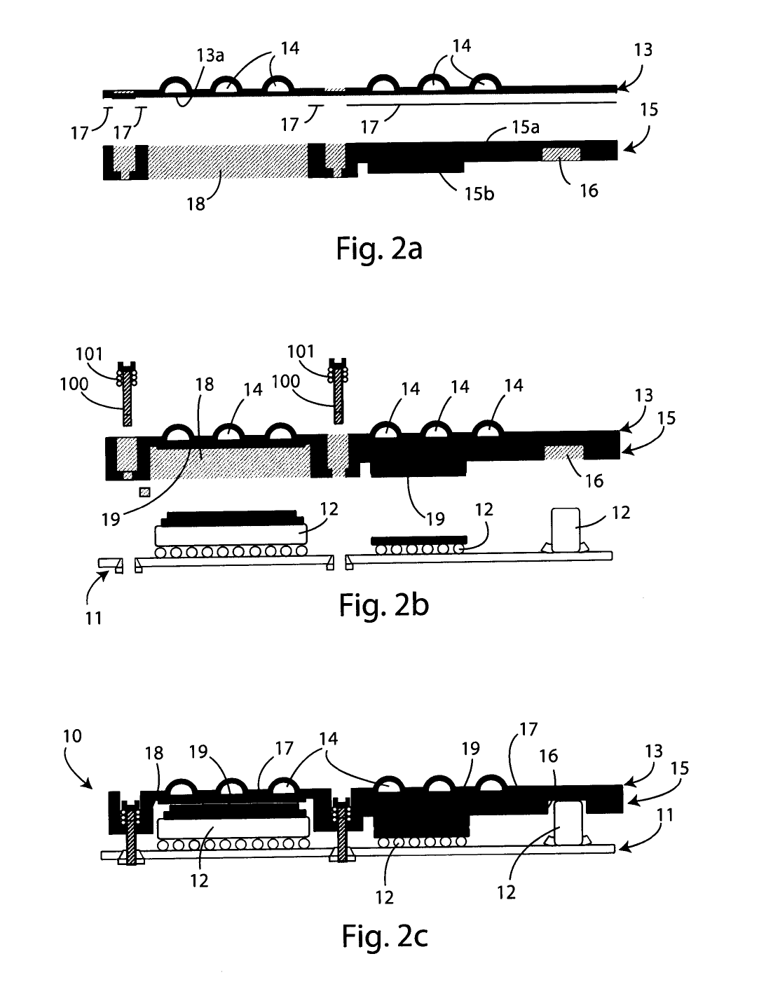

FIGS. 2a, 2b, and 2c illustrate simplified diagrams of steps of the process to produce a cooled electronic board for supercomputing according to the invention;

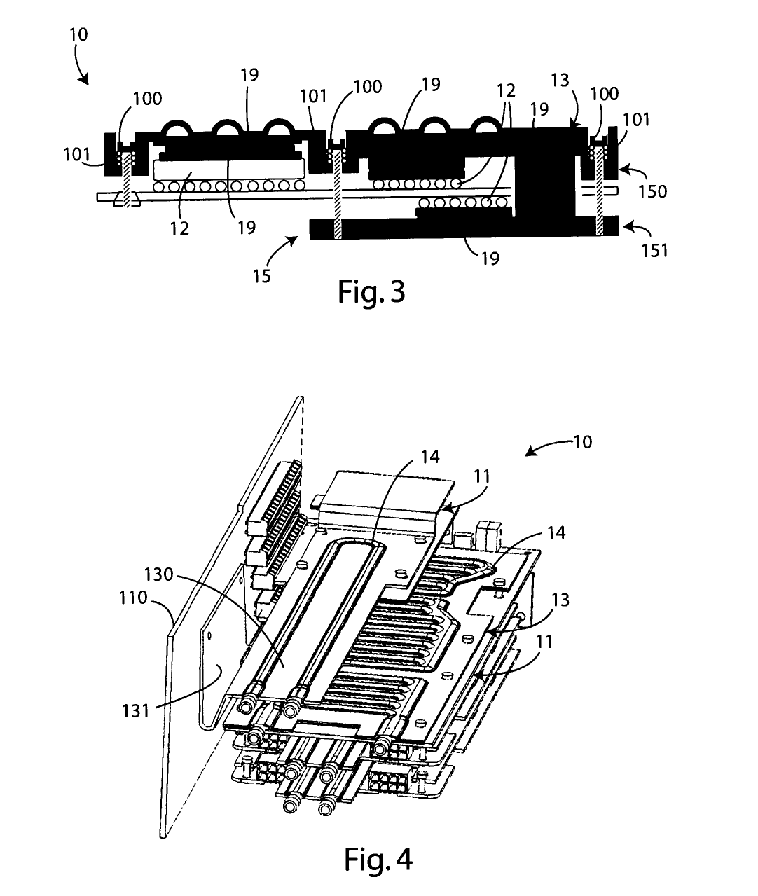

FIG. 3 illustrates a simplified diagram of a variation of a cooled electronic board for supercomputing according to the invention, in a front view;

FIG. 4 illustrates a further variation of the cooled electronic board for super computing according to the invention in a perspective view.

With particular reference to the mentioned figures, a cooled electronic board for supercomputing 10 is globally indicated with 10, comprising a printed electronic circuit 11 whereon at least an electronic component 12 is fixed.

Advantageously, on the printed electronic circuit 11 a plurality of electronic components 12 are fixed and distributed according to positioning criteria defined by the electronic circuit to be obtained.

According to the present invention, the cooled electronic board for supercomputing 10 presents a peculiarity in the fact that it comprises a heat exchanger 13 of the roll bond type thermally connected to the electronic components 12 to absorb, in use, a thermal flow generated by the latter.

Advantageously, the heat exchanger 13 has a flat face 13a thermally connected to the electronic components.

Preferably, the refrigerant fluid passage channels 14 of the heat exchanger 13 are distributed in such a way that the heat exchanger 13, in use, absorbs a larger heat flow where it is thermally connected to the electronic components 12 which produce larger heat per surface unit.

In other words, the heat exchanger 13 is configurable in such a way that in the hottest zones, in the jargon called hot spots, i.e wherein the absorption of a larger thermal flow is required, a larger number of channels 14 is provided, the total outflow section of refrigerant fluid being equal.

In the practice, thanks to the easiness and flexibility by means of which the channels 14 can be disposed along the extension of the heat exchanger 13, it is possible to obtain a cooling efficiency of the electronic circuits, constituted by systems of electronic components 12, even very complex from the point of view of distribution on the printed electronic circuit 11 of the electronic components 12.

Advantageously, the cooled electronic card 10 for supercomputing comprises a thermal connection element 15, thermally conductive, thermally connected to and interposed between the electronic component 12 and the heat exchanger 13 to transmit heat between the latter.

Advantageously, the printed electronic circuit 11, the thermal connection element 15, if provided, and the heat exchanger are reciprocally connected by means of connection elements 100 preferably comprising screws and/or nuts.

The cooled electronic board 10 for supercomputing advantageously comprises elastic elements 101 preferably comprising the compression springs, acting between the printed electronic circuit 11 and the heat exchanger 13 or the thermal connection element 15, if provided, and configured to elastically contrast the reciprocal approaching of the printed electronic circuit 11 respectively to the heat exchanger 13 or the thermal connection element 15.

With particular reference to the enclosed figures, the elastic elements 101 are there represented by way of illustration and not by way of limitation, as springs acting between the connection elements 100 and the thermal connection element 15.

In practice, the above elastic elements 101 preferably act in a direction which is parallel to the direction of action of the connection elements 100.

Advantageously, the connection elements 100, and the possible elastic elements 101 are distributed with respect to the printed electronic circuit 11 and the heat exchanger 13 or the thermal connection element 15 in such a way that the pressure exerted by the heat exchanger 13 or the thermal connection element 15 on the electronic components 12 fixed to the printed electronic circuit 11 is substantially uniform, i.e. the same pressure acts on each electronic component 12, so that the dissipation of the generated heat comes out to be optimized, during the use, by the electronic components 12.

The cooled electronic for 10 for supercomputing preferably comprises an adhesive 17, thermally conductive, interposed between the heat exchanger 13 and the thermal connection element 15 to fix them reciprocally.

In general, the adhesive 17 is chosen in such a way to present a thermal expansion coefficient which is substantially equal to that of the material wherein the thermal connection element 15 and the heat exchanger 13 are realized, in such a way to avoid differential deformations of the adhesive 17, the thermal connection element 15 and the heat exchanger 13 during the functioning of the cooled electronic board 10 for supercomputing, so as to make long-standing the whole of the thermally conductive interface between the heat exchanger 13 and the thermal connection element 15.

Preferably, the thermal connection element 15, and/or the heat exchanger 13 are realized in an aluminium alloy, and advantageously they are realized in an aluminium alloy chosen among those which are termed thermal alloys such as for example the alloy EN AW 6082.

In the embodiments providing the thermal connection element 15 as formed in aluminium, the adhesive 17 is advantageously a thermal glue based on aluminium particulate, to guarantee the chemical stability of the interface.

Advantageously, the adhesive polymerizes at ambient temperature within a time span shorter than 24 hours.

Advantageously, the adhesive 17 has a thermal conductivity, under operative conditions, higher than 1 W/mK and preferably equal to 5 W/mK.

The adhesive 17 is preferably applied by serigraphy to the heat exchanger 13 and/or the thermal connection element 15, before their connection.

In a first and preferred embodiment of the thermal connection element 15, according to the invention, which is shown by way of illustration by not by way of limitation in the enclosed figures, the thermal connection element 15 is constituted by a conductive plate covering substantially the whole portion of the heat exchanger 13 which is destined to absorb heat from the electronic components 12.

Preferably, the thermal connection element 15 has the first face 15a, to which the heat exchanger 13 is fixed, which is advantageously fixed on the flat face 13a, and a second face 15b provided with at least a seat 16 which is shaped to correspond to electronic component 12, to house it by insertion.

According to said first embodiment, the thermal connection element 15 has advantageously at least a through cavity 18 wherein at least one of the electronic components 12 is insertable, which is connected to or is facing the heat exchanger 13 in order to, in use, exchange heat directly with the latter.

In general, irrespective of the embodiment of the thermal connection element 15, the distance between the printed electronic circuit 11 and the flat face 13a of the heat exchanger 13 is chosen equal to the protrusion, with respect to the printed electronic circuit 11, the electronic component 12 generating more heat per surface unit, in use, with respect to the other electronic components 12 mounted on the printed electronic circuit 11.

This electronic component 12 producing more heat per surface unit is preferably placed in contact with the heat exchanger 13 directly or by the adhesive 17 or by means of a transmission element 19, which will be treated more in detail in the following.

In the case the cooled electronic board 10 for supercomputing comprises, fixed on the printed electronic circuit 11, first electronic components having a protrusion larger on the printed electronic circuit 11 than a second electronic element which produces more heat per surface unit in use, the exchanger 13 preferably presents apertures, not shown, which are crossed by first electronic components in the case wherein the latter do not need cooling in use, or, alternatively, the first electronic elements are fixed in direct contact with the heat exchanger 13 and at least a portion of the thermal connection element 15 is provided, which is connected to the second electronic component and the heat exchanger 13 to exchange heat between the latters.

According to a second embodiment of the invention, not shown in the enclosed figures, the thermal connection element 15 is constituted by a plurality of distinct blocks, advantageously in aluminium or aluminium alloy, which are coupled to the heat exchanger 13, preferably by the adhesive 17.

The first of said embodiments is preferable in the case wherein the board profile, and in particular the profile of the electronic components to be cooled down, is very articulated with many electronic components to be cooled down, which have heights that are even very different with respect to each other.

The above embodiment is in general preferable and advantageous in the case wherein the electronic components to be cooled down are very few or have heights which are not much different, and therefore they can be placed in connection with a common block.

The second embodiment allows to achieve a remarkable reduction of weight of the cooled electronic board 10 for supercomputing.

The cooled electronic board 10 for supercomputing advantageously comprises also a transmission element 19 superimposed to the electronic component 12 and thermally connected to the heat exchanger 13 to transmit heat between the electronic component 12 and the heat exchanger 13.

The transmission element 19 advantageously comprises a thermal mat or thermal grease.

For reason of cleaning and order the thermal mat is preferable with respect to the thermal grease.

This thermal mat has advantageously a thermal conductivity comprised between 2.5 W/mK and 15 W/mK and preferably has a hardness comprised between SHORE00 10 (soft) and SHORE00 65 (hard).

Preferably, the thickness of the thermal mat, when it is not compressed, is comprised between 0.5 mm (for the hard ones) and 2.0 (for the soft ones).

In use, such thermal mats present advantageously a compression of 50%, in the case of soft mats, or 30% in the case of hard mats.

The elastic elements 101 are preferably constituted by springs which, in use, present a compression of 50%.

Such springs and thermal mats are chosen in such a way that the springs have an elastic constant such that, in use, the thermal mats have a compression of 50%, if they are soft, or 30% if they are hard, the thermal conductivity of the thermal mats being optimized, in correspondence of said compressions.

Advantageously, the thermal mats and the springs are configured in such a way that when the cooled electronic board 10 for supercomputing is in use and when it is not in use, one has a variation of the compression of the thermal mats that is shorter than 10%.

The cooled electronic board 10 for supercomputing is configured in such a way that both the above compression and the above compression variation can be indirectly set and verified by the use of a dynamometric screwdriver or equivalent tool whose reference value is set with reference to the compression-force graph relevant to the specific type of utilized thermal mats.

Advantageously, the distribution of the channels 14 is chosen in such a way to obtain a good cooling capillarity of the whole cooled electronic board 10 for supercomputing, in order to avoid critical temperature differences in particular during the functioning transients of the cooled electronic board 10 for supercomputing.

Preferably, the channels distribution 14 is chosen in such a way that the heat exchanger 13 does not present areas having a surface larger than 2.5 cm×2.5 cm that are not crossed by at least a channel 14.

In correspondence of zones of the heat exchanger 13 requiring a larger thermal dissipation, preferably a larger ramification of the channels 14 is provided, i.e. a channel is subdivided into a plurality of channels 14 in correspondence of the zone which requires larger thermal dissipation.

Such larger ramification of the channels 14 brings the further advantage of reducing the pressure loss through the same channels 14.

Preferably, the channels 14 of a heat exchanger 13 are configured in such a way to present a total hydraulic load loss smaller than 0.5 bar.

In the case wherein holes or apertures are provided on the heat exchanger 13, for example for the insertion of one or more electronic components 12 and/or that can be engaged by the connection elements, the distance of the edge of such holes/apertures from the closest channel 14 is preferably not less than 15 mm in the lamination direction of the roll bond and not less than 10 mm in the direction perpendicular to said lamination direction.

The cooled electronic board 10 for supercomputing advantageously comprises guide elements shaped in such a way to slidably couple with guides provided in a containment shell of the cooled electronic board 10 for supercomputing.

Such guide elements are advantageously integral or fixed to the thermal connection element preferably on its longitudinal edges.

In a realization variation, such guide elements can be directly coupled to the dissipator 13 preferably by means of screws or adhesive.

Advantageously, the cooled electronic board 10 for supercomputing comprises connectors, not shown, hydraulically connected to the channels 14 and connectable to a channels feeding circuit 14.

Preferably such connectors are fixed, preferably by glue or screws to the thermal connection element 15.

Advantageously, such connectors are fixed on support blocks presenting threaded housings which in turn are fixed to the thermal connection element 15, preferably by glue or screws.

In such a way, the thermal connection element 15 will bear the mechanical stresses deriving from the insertion/extraction of the connectors in/from the counterparts.

In an advantageous embodiment of the invention illustrated in the enclosed figures, the front panel of the cooled electronic board 10 for supercomputing, and possible handles for the extraction and insertion of the latter in a housing provided to this end, are fixed to the thermal connection element 15.

Alternatively, said the front panel and said handles are fixed to support blocks, preferably in aluminium and fixed, in turn, to the thermal connection element 15, by means of glue and/or screws.

In the case wherein the cooled electronic board 10 for supercomputing is to be inserted in a housing or container, making it slide on guides and wherein it is of large dimensions and the thermal connection element 15 is not present or it consists of distinct blocks, then it is preferable to provide stiffening elements adapted to stiffen the cooled electronic board 10 for supercomputing to avoid deformation of the latter particularly during the extraction/insertion.

This is made to allow the stiffening elements, and not the printed electronic circuit 11 or the heat exchanger 13, to absorb the mechanical stresses of insertion/extraction.

Said stiffening elements comprise preferably ribs applied to the heat exchanger 13.

Advantageously, said ribs can be slidably coupled to the above guides in order to guide the cooled electronic board 10 for supercomputing during the insertion/extraction from said housing.

In the case the thermal connection element 15 is provided, which is substantially shake to correspond to the printed electronic circuit 11, the latter will absorb the stresses without the necessity of further additions.

Preferably, electronic components 12 are provided which protrude from two opposite faces of the printed electronic circuit 11.

In such a case, the cooled electronic board for supercomputing advantageously comprises two heat exchangers 13 each connected to the electronic components 12 of one of these faces.

Alternatively, according to the example shown by way of illustration but not by way of limitation in FIG. 3, the thermal connection element 15 comprises a first branch 150, in thermal connection with the electronic components fixed on a first one of these faces, and a second branch 151, in thermal connection with the electronic components fixed on the second one of these faces.

Preferably, the electronic components 12 on the second face of the printed electronic circuit 11 have a transmission element 19, as above described, which do place them in contact with the thermal exchanger 13.

Moreover, the two branches 150 and 151 are preferably thermally connected by means of a thermal mat as above described and what has been said for the above previous thermal mats apply also to said thermal mat.

The efficiency and effectiveness of such transmission element 19 in view of the heat transfer are obtained by a screws system which clamps the two thermal connection elements 150 and 151 with each other. According to a realization variation illustrated in FIG. 4, the heat exchanger can advantageously be shaped in such a way to extend at least in two directions that are not reciprocally coplanar.

In other words, the heat exchanger 13 can comprise two portions 130 and 131 respectively thermally connected with electronic components fixed on a first printed electronic circuit 11 and on a second printed electronic circuit 110.

The two portions 130 and 131 are preferably connected by a fold in correspondence to which channels 14 can be provided.

Preferably, the channels 14 in correspondence of said fold are subdivided into a plurality of lower opening channels to avoid narrowings of the same channels during the operations of formation of said fold.

Preferably, but differently from what is illustrated in the figure, such channels are developed on the side of the heat exchanger 13 for which the folding angle is obtuse.

It is subject matter of the present invention also a process for producing a cooled electronic board 10 for supercomputing that presents a peculiarity in the fact of providing:

forming the heat exchanger 13 of the roll bond type with a plurality of channels 14 configured in such a way to determine, in use, a differentiated capacity of heat exchange along the extension of the heat exchanger 13;

thermally connecting the heat exchanger 13 to the electronic component 12.

Advantageously, the process according to the invention provides for connecting the heat exchanger 13 to the printed electronic circuit 11.

Preferably, such process comprises:

forming a thermal connection element 15 made of a material that is thermally conductive and provided with at least a seat 16 and/or at least a through cavity 18 adapted to house the electronic component 12 in order to, in use, exchange heat between the thermal connection element 15 and the electronic component 12;

thermally connecting the first face 15a of the thermal connection element 15 to the heat exchanger 13, preferably by means of a thermo-conductive adhesive, and inserting the electronic component 12 in the seat 16 or in the through cavity 18.

Preferably, the process according to the invention provides preliminary joining the heat exchanger 13 and the thermal transmission element 15 in such a way to form an intermediate product, and subsequently it provides for joining said product to the printed electronic circuit 11, preferably by means of the above connection elements 100, advantageously providing the presence of the elastic elements 101.

The step of thermally connecting a first face 15a of the thermal connection element 15 to heat exchanger 13 advantageously comprises the gluing of determined connection element 15 to the heat change 13 by means of predefined amount of an adhesive 17, thermally conductive, disposed on at least a predefined region of the thermal connection element 15 or the heat exchanger 13.

Advantageously, in order to obtain a precise control of the dosage, and cleaning, said process provides for the application of the adhesive 17 by serigraphy.

In particular, the application of the adhesive 17 preferably provides for the preparation of a stencil whereon the adhesive 17 is disposed according to a design reproducing the form corresponding to the heat exchanger 13 or the thermal connection element 15 whereon the adhesive 17 is to be applied.

The relationship between the thickness of the stencil and the ratio between the surface engaged by the adhesive on the stencil and that to be engaged with the adhesive on the heat exchanger 13 is chosen in such a way to guarantee a minimum and uniform thickness of adhesive 17 to the end of optimizing the efficiency and effectiveness of thermal transmission.

Preferably the thickness of the adhesive 17, in use, is less than 0.100 mm being the surface roughness of the thermal connection element 15, whereon the adhesive is disposed, substantially much smaller than 0.50 mm.

The stencil has preferably a thickness of 0.125 mm.

Advantageously, the area of the surface engaged by the adhesive 17 on the stencil Ad, is chosen before the application in such a way to respect the following formula wherein Ai indicates the area to be glued, i.e. the area of the surface of the heat exchanger 13 to be glued to the thermal connection element 15 or the electronic components 12: 0.100 mm×Ai=0.125 mm×Ad×k, wherein k is a constant having value equal to the volume reduction percentage which the adhesive 17 presents during the polymerization, which is typical of the chosen adhesive 17 and variable from adhesive to adhesive.

In any case, the distribution of the adhesive 17 on stencil is chosen in such a way to obtain a total covering of the surfaces to join by means of the adhesive 17.

Preferably, said process provides for fixing at least a transmission element 19, thermally conductive, to the electronic component 12 and thermally connecting the transmission element 19 to the heat exchanger 13.

The transmission element 19 can have more or less the same form of the printed electronic circuit 11 or can be substituted by a multiplicity of isolated blocks performing the same function.

Both the positioning of the stencil for the serigraphy and the positioning of the transmission element 19 or the thermal connection element 15 or alternatively the multiplicity of blocks occurs preferably by means of reference templates.

In the practice, it is easy to observe that the above cooled electronic board for supercomputing according to the invention and the process to produce it achieve the proposed task and objects. Indeed, a cooled electronic board for the supercomputing according to the invention comes out to be more compact than the traditional cooled boards thanks to the use of the exchanger of the roll bond type which allows to highly reduce the dimensions and the weight.

The heat exchanger would be able to be placed directly in contact with electronic components to be refrigerated or may be in contact with some of these by means of a thermal connection element and/or a transmission element.

A cooled electronic board for the supercomputing according to the invention presents a cooling that is more effective with respect to the traditional boards because it allows to have an intensified cooling in the zones that there are to be better refrigerated (hot spots) thanks to the flexibility of disposition of the cooling channels along the cooled electronic board for supercomputing.

Moreover, a cooled electronic board for supercomputing according to the invention allows to obtain a differentiated cooling capability along its own extension in a simpler and more efficient way, with respect to the traditional boards.

Moreover, a cooled electronic board for supercomputing according to the present invention is structurally simpler with respect to the traditional ones.

The process to produce a cooled electronic board for supercomputing according to the present invention comes out to be simpler with respect to the traditional processes and allows to obtain in a more flexible way cooled boards in a differentiated way along its own extension.

The so conceived invention is susceptible of a number of modification and variations, all falling within the scope of the enclosed claims.

Moreover, all the details can be substituted by other elements that are technically equivalent.

In the practice, the used materials can be varied depending on the contingent needs and the state of the art.

When the constructive features and the techniques mentioned in the following claims are followed by reference signs or numbers, such reference signs or numbers are given with the only object of increasing the intelligibility of the same claims and, as a consequence, they do not constitute in any way a limitation to the interpretation of each element identified, only by way of example, by such reference signs or numbers.

1. Cooled electronic board (10) for supercomputing comprising a printed electronic circuit (11) whereon at least an electronic component (12) is fixed and characterized in that it comprises a heat exchanger (13) of the roll bond type thermally connected to said electronic component (12) to absorb, in use, a thermal flow generated by said electronic component (12; the printed electronic circuit (11) and the heat exchanger (13) been reciprocally connected by means of connection elements (100); wherein the cooled electronic board (10) further comprises elastic elements (101) acting between the printed electronic circuit (11) and the heat exchanger (13) and are configured to elastically contrast the reciprocal approaching of the printed electronic circuit (11) respectively to the heat exchanger (13); wherein the pressure exerted by said heat exchanger (13) on said electronic component (12) is substantially uniform, i.e. the same pressure acts on each electronic component (12), in order to optimize the dissipation of the heat generated, during the use, by said electronic component (12).

2. Cooled electronic board (10) for supercomputing according to claim 1, characterized in that it comprises a thermal connection element (15), thermally conductive, thermally connected to and interposed between said electronic component (12) and said heat exchanger (13) to transmit heat between the latters.

3. Cooled electronic board (10) for supercomputing according to claim 2, characterized in that said thermal connection element (15) has a first face (15a) to which said heat exchanger (13) is fixed and a second face (15b) provided with at least a seat (16) that is shaped to correspond to said electronic component (12) in order to house it by insertion.

4. Cooled electronic board (10) for supercomputing according to claim 2, characterized in that it comprises a thermally conductive adhesive (17), interposed between said heat exchanger (13) and said thermal connection element (15) to mutually fix them.

5. Cooled electronic board (10) for supercomputing according to claim 2, characterized in that said thermal connection element (15) has at least a through cavity (18), said electronic component (12) being inserted in said through cavity (18) and connected to or facing said heat exchanger (13) in order to, in use, exchange heat directly with the latter.

6. Cooled electronic board (10) for supercomputing according to claim 1, characterized in that it comprises a transmission element (19) superimposed to said electronic component (12) and thermally connected to said heat exchanger (13) in order to transmit heat between said electronic component (12) and said heat exchanger (13).

7. (canceled)

8. Cooled electronic board (10) for supercomputing according to claim 2, characterized in that said thermal connection element (15) is constituted by a conductive plate covering substantially the whole portion of said heat exchanger (13), which is destined to absorb heat from said electronic components (12).

9. Cooled electronic board (10) according to claim 2, characterized in that said thermal connection element (15) is constituted by a plurality of distinct blocks, coupled to said heat exchanger (13).

10. Cooled electronic board (10) for supercomputing according to claim 1, characterized in that the distribution of the channels (14) of said heat exchanger (13) is chosen in such a way to avoid critical temperature differences in particular during the transients of functioning of the cooled electronic board (10) for supercomputing.

11. Cooled electronic board (10) for supercomputing according to claim 1, characterized in that said thermal connection element (15) comprises a first branch (150), in thermal connection with electronic components fixed on a first face of said printed electronic circuit (11), and a second branch (151), in thermal connection with electronic components fixed on a second face of said printed electronic circuit (11).

12. Cooled electronic board (10) according to claim 1, characterized in that said heat exchanger (13) may comprise two portions (130, 131) respectively thermally connected to electronic components fixed on a first printed electronic circuit (11) and on a second printed electronic circuit (110).

13. Process for producing a cooled electronic board (10) for supercomputing comprising a printed electronic circuit (11) whereon at least an electronic component (12) and a heat exchanger (13) of the roll bond type is fixed, according to claim 1, characterized in that it provides:
forming said heat exchanger (13) of the roll bond type with a plurality of channels (14) configured in such a way to determine, in use, a capability of heat exchange, which is differentiated along the extension of said heat exchanger (13);
thermally connecting said heat exchanger (13) to said electronic component (12).

14. Process according to claim 13, characterized in that it comprises:
forming a thermal connection element (15) made of a thermally conductive material and provided with at least a seat (16) and/or at least a through cavity (18) adapted to house said electronic component (12) in order to, in use, exchange heat between said thermal connection element (15) and said electronic component (12);
thermally connecting the first face (15a) of said thermal connection element (15) to said heat exchanger (13) and inserting said electronic component (12) in said seat (16) or through cavity (18).

15. Process according to claim 14, characterized in that said step of thermally connecting a first face (15a) of said thermal connection element (15) to said heat exchanger (13) comprises the gluing of said thermal connection element (15) to said heat exchanger (13) by means of predefined amount of thermally conductive adhesive (17) disposed on at least the predefined region of said thermal connection element (15) or said heat exchanger (13).

16. Process according to claim 15, characterized in that said gluing step provides that said adhesive (17) is applied by serigraphy to said heat exchanger (13) and/or to said thermal connection element (15), before their union.

17. Process according to claim 14, characterizing in that it comprises the fixing of at least a transmission element (19), thermally conductive, to said electronic component (12) and thermally connecting said transmission element (19) to said heat exchanger (13).

18. Process according to claim 17, characterized in that it provides a first step of joining said heat exchanger (13) and said thermal transmission element (15) in such a way to form an intermediate product, and a second step of joining said product to said printed electronic circuit (11).

19. Cooled electronic board (10) for supercomputing according to claim 2, characterized in that the printed electronic circuit (11), the thermal connection element (15) and the heat exchanger (13) are reciprocally connected by means of connection elements (100)

20. Cooled electronic board (10) for supercomputing according to claim 2 characterized in that it comprises elastic elements (101) acting between the printed electronic circuit (11) and the heat exchanger (13) or the thermal connection element (15), and configured to elastically contrast the reciprocal approaching of the printed electronic circuit (11) respectively to the heat exchanger (13) or the thermal connection element (15).

21. Cooled electronic board (10) for supercomputing according to claim 2, characterized in that the pressure exerted by said thermal connection element (15) on said electronic components (12) is substantially uniform, i.e. the same pressure acts on each electronic component (12), in order to optimize the dissipation of the heat generated, during the use, by said electronic components (12).
